(19) United States
(12) Patent Application Publication
(10) Pub. No.: US 2016/0148296 A1
(43) Pub. Date: May 26, 2016

(54) METHOD AND SYSTEM FOR PROVIDING A PROFILE ASSOCIATED WITH A CARDHOLDER

(71) Applicant: MasterCard International Incorporated, Purchase, NY (US)

(72) Inventors: Pedro Chavarria, Hampton Bays, NY (US); Kristofer Perez, New York, NY (US)

(21) Appl. No.: 14/554,793

(22) Filed: Nov. 26, 2014

(51) Int. Cl. G06Q 30/06; G06Q 20/40; G06Q 20/10

(52) U.S. Cl. CPC G06Q 30/0631; G06Q 20/10; G06Q 20/40

(57) ABSTRACT

A computer-implemented method for providing a profile associated with a cardholder to a suggestion computing device is provided. The method is implemented using a computing device in communication with one or more memory devices. The method includes retrieving, from the one or more memory devices, stored transaction data associated with a plurality of purchases made by a cardholder using a payment card and processed over a payment network. The method additionally includes determining at least one interest of the cardholder based on the stored transaction data, storing the at least one determined interest in a profile associated with the cardholder, and transmitting the cardholder profile to the suggestion computing device for use in suggesting one or more goods to the cardholder.

### BACKGROUND

This description relates to processing payment transactions, and more specifically to determining interests of a cardholder based on payment transaction data associated with the cardholder.

Known systems provide suggestions for products and/or services (collectively “goods”) to a person based on interests of the person. Known systems that attempt to determine interests of the person are operated by a single merchant of a specific set of goods. More specifically, such systems generally require the person to be an existing customer and to purchase or otherwise choose certain goods from the specific merchant in order for the system to determine the interests of the person. Further, the scope of the determined interests is limited to the range of goods offered by the specific merchant. Other known systems require a person to expressly describe or select their interests from a set of choices, rather than determining the interests of the person based on their purchasing behavior. In summary, known systems fail to determine interests of a person based on purchases made by the person across multiple merchants. Accordingly, in known systems, any suggestions generated from the determined interests of a person are based on a relatively-limited set of information and may fail to include many goods that the person would be interested in purchasing.

### BRIEF DESCRIPTION OF THE DISCLOSURE

In one aspect, a computer-implemented method for providing a profile associated with a cardholder to a suggestion computing device is provided. The method is implemented using a computing device in communication with one or more memory devices. The method includes retrieving, from the one or more memory devices, stored transaction data associated with a plurality of purchases made by a cardholder using a payment card and processed over a payment network. The method additionally includes determining at least one interest of the cardholder based on the stored transaction data, storing the at least one determined interest in a profile associated with the cardholder, and transmitting the cardholder profile to the suggestion computing device for use in suggesting one or more goods to the cardholder.

In another aspect, a computing device for providing a profile associated with a cardholder to a suggestion computing device is provided. The computing device includes one or more processors in communication with one or more memory devices. The computing device is configured to retrieve, from the one or more memory devices, stored transaction data associated with a plurality of purchases made by a cardholder using a payment card and processed over a payment network. The computing device is additionally configured to determine at least one interest of the cardholder based on the stored transaction data, store the at least one determined interest in a profile associated with the cardholder, and transmit the cardholder profile to the suggestion computing device for use in suggesting one or more goods to the cardholder.

In yet another aspect, a computer-readable storage medium having computer-executable instructions embodied thereon is provided. When executed by a computing device having one or more processors in communication with one or more memory devices, the computer-executable instructions cause the computing device to retrieve, from the one or more memory devices, stored transaction data associated with a plurality of purchases made by a cardholder using a payment card and processed over a payment network, determine at least one interest of the cardholder based on the stored transaction data, store the at least one determined interest in a profile associated with the cardholder, and transmit the cardholder profile to the suggestion computing device for use in suggesting one or more goods to the cardholder.

### BRIEF DESCRIPTION OF THE DRAWINGS

FIGS. 1-11 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example payment processing system that includes a suggestion computing device and other computing devices in accordance with one example embodiment of the present disclosure.

FIG. 3 is an expanded block diagram of an example embodiment of a server architecture of the payment processing system including the suggestion computing device and a plurality of other computing devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a block diagram of an example relationship between cardholders, merchants, and categories that the cardholders fall into based on purchases from the merchants.

FIG. 7 is a block diagram of an example relationship between categories of cardholders and interests associated with the categories.

FIG. 8 is a block diagram of an example data flow from purchases made by a cardholder to a profile of the cardholder.

FIG. 9 is a block diagram of example communications among a cardholder, a server system, and the suggestion computing device of FIG. 2.

FIG. 10 is a flowchart of an example process that may be performed by the payment processing system for providing a profile associated with a cardholder to the suggestion computing device of FIG. 2.

FIG. 11 is a diagram of components of one or more example computing devices that may be used in embodiments of the described systems and methods.

### DETAILED DESCRIPTION OF THE DISCLOSURE

Implementations of the method and system described herein generate a profile for a cardholder based on purchases made by the cardholder through a payment processing network. More specifically, the system determines at least one interest (e.g., golf) of the cardholder and stores the interest in the profile. The system transmits the profile to a suggestion computing device. The suggestion computing device generates and provides suggestions to the cardholder to purchase a good. In some implementations, the suggestion computing device is associated with a third party. More specifically, the suggestion computing device may be a third party website that presents suggestions to the cardholder to purchase one or more goods.

In some implementations, the system compares purchases made by the cardholder to a reference set of purchases made by another cardholder to determine one or more interests of the cardholder. Additionally, in some implementations, the system associates the cardholder with a category based on the purchases made by the cardholder. For example, the system may associate the cardholder with an age category, a hobby category, an income category, a marital status category, or other category. Each category is associated with goods that people (e.g., cardholders) within the category tend to purchase.

In some implementations, the system determines a likelihood that the cardholder will purchase a particular good that the cardholder has not already purchased, according to the stored transaction data. For example, the likelihood may be expressed as a likelihood score, which may be, for example, a percentage or other number. Accordingly, in such implementations, the suggestion computing device presents suggestions to purchase goods that meet or exceed a certain threshold likelihood score. In some implementations, the system identifies at least one interest of the cardholder based on a merchant (i.e., a golf store) from whom the cardholder purchased at least one good within a predetermined time period. In some implementations, the system determines an average transaction amount and/or a frequency associated with purchases with the merchant. Some implementations of the system use such information to further determine the cardholder's level of interest in the goods sold by the merchant and which category or categories the cardholder falls into.

The methods and systems described herein may be implemented using computer programming or engineering techniques including computer software, firmware, hardware or any combination or subset thereof, wherein the technical effect may include at least one of: (a) retrieving, from one or more memory devices, stored transaction data associated with a plurality of purchases made by a cardholder using a payment card and processed over a payment network; (b) determining at least one interest of the cardholder based on the stored transaction data; (c) storing the at least one determined interest in a profile associated with the cardholder; and (d) transmitting the cardholder profile to the suggestion computing device for use in suggesting one or more goods to the cardholder.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

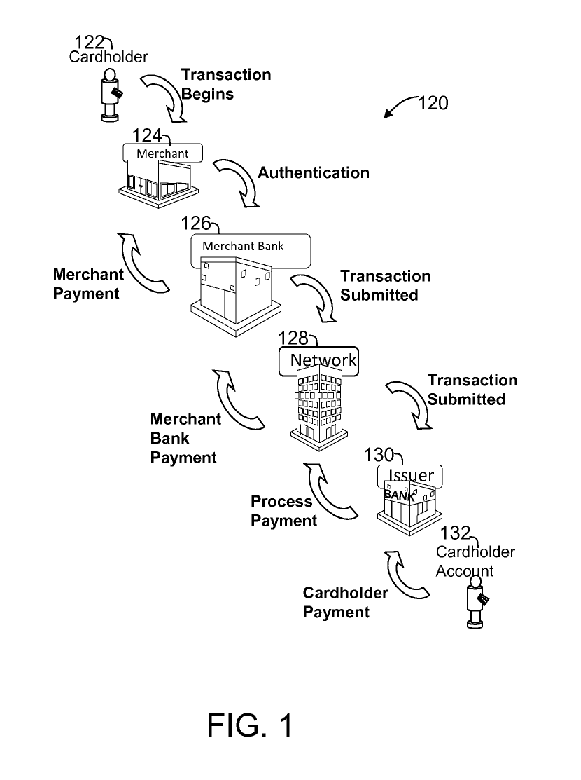

FIG. 1 is a schematic diagram illustrating an example multi-party payment card system 120 for enabling ordinary payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer 130 issues a payment card for an account, such as a credit card account or a debit card account, to a cardholder 122, who uses the payment card to tender payment for a purchase from a merchant 124. To accept payment with the payment card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment card (also known as a financial transaction card), merchant 124 requests authorization from acquirer 126 for the amount of the purchase. Such a request is referred to herein as an authorization request message. The request may be performed over the telephone, but is usually performed through the use of a point-of-interaction terminal, also referred to herein as a point-of-sale device, which reads the cardholder's account information from the magnetic stripe on the payment card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. Based on these determinations, the request for authorization will be declined or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the products or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 132 is decreased. Normally, a charge is posted immediately to cardholder's account 132. The bankcard association then transmits the approval to the acquiring processor for distribution of products/services, or information or cash in the case of an ATM.

After a transaction is captured, the transaction is settled between merchant 124, acquirer 126, and issuer 130. Settlement refers to the transfer of financial data or funds between the merchant's account, acquirer 126, and issuer 130 related to the transaction. Usually, transactions are captured and accumulated into a “batch,” which is settled as a group.

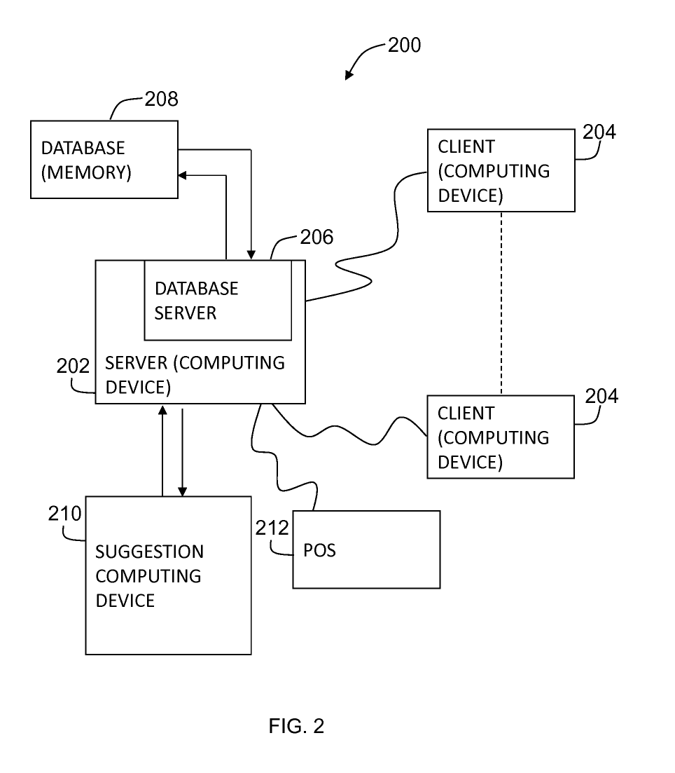

FIG. 2 is a simplified block diagram of a payment processing system 200 that includes a suggestion computing device 210 and other computing devices in accordance with one embodiment of the present disclosure. In the example embodiment, system 200 includes a server system 202 and a plurality of client subsystems, also referred to as client systems 204 or client computing devices, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized. Server system 202 could be any type of computing device configured to perform the steps described herein. System 200 includes at least one point-of-sale device 212 in communication with server system 202. Additionally, suggestion computing device 210 is in communication with server system 202. In some implementations, suggestion computing device 210 is incorporated into or integrated within server system 202.

As discussed below, payment processing system 200 processes payments from transactions between cardholders and merchants. For example, one or more such transactions may be initiated at at point-of-sale device 212. In processing such payments, server system 202 accesses and populates card transaction data (“transaction data”), stored in database 208. The transaction data includes, for example, merchant identifiers, merchant locations, transaction amounts, product identifiers (e.g., stock keeping units (SKUs)), cardholder identifiers, and transaction dates. Server system 202 analyzes such transaction data and generates a profile associated with at least one cardholder, such as cardholder 122 and transmits the profile to suggestion computing device 210. As described herein, the profile includes information regarding one or more interests of cardholder 122. Suggestion computing device 210 utilizes the profile to transmit a suggestion to cardholder 122 to purchase a good.

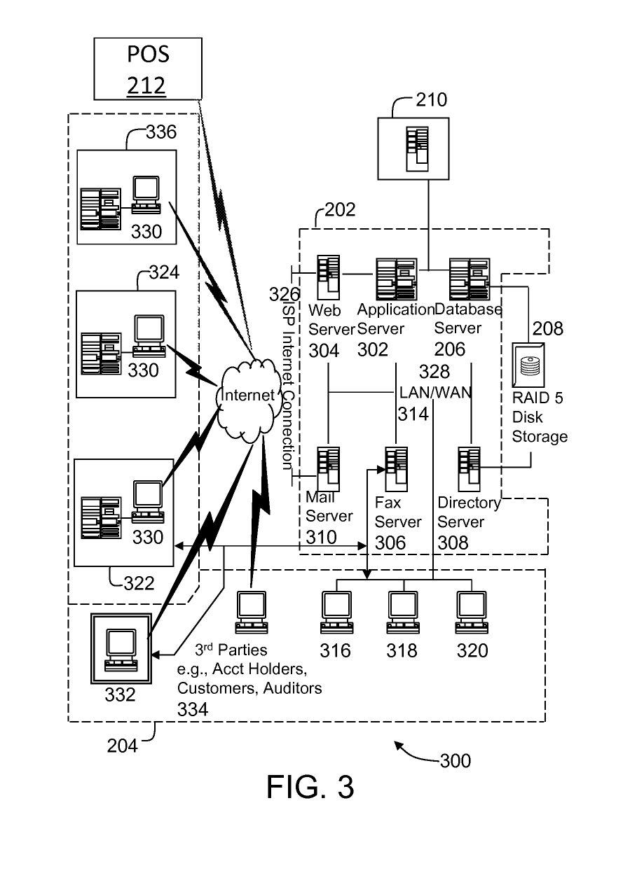

FIG. 3 is an expanded block diagram of an example embodiment of a server architecture of payment processing system 200 in accordance with one embodiment of the present disclosure. Payment processing system 200 includes server system 202, client systems 204, suggestion computing device 210, and point-of-sale device 212. Server system 202 includes database server 206, an application server 302, a web server 304, a fax server 306, a directory server 308, and a mail server 310. Database 208 (e.g., a disk storage unit), is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322 and issuers 324, and to third parties, e.g., auditors, 334 using an Internet connection 326. Server system 202 is also communicatively coupled with at least one merchant 336. Server system 202 is also communicatively coupled to at least one point-of-sale device 212 and to suggestion computing device 210. In some embodiments, suggestion computing device 210 is integrated within server system 202. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

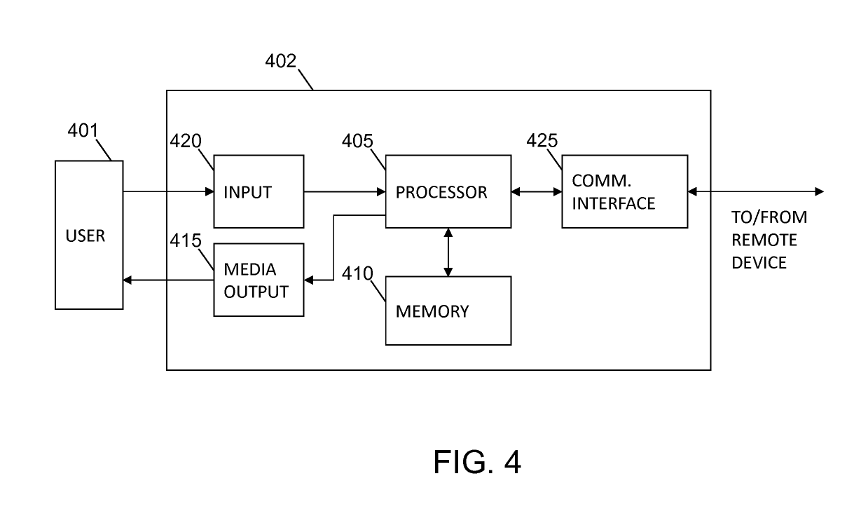

FIG. 4 illustrates an example configuration of a cardholder computing device 402 operated by a user 401. User 401 may include cardholder 122 (FIG. 1). Cardholder computing device 402 may include, but is not limited to, client systems (“client computing devices”) 204, 316, 318, and 320, workstation 330, and manager workstation 332 (shown in FIG. 3). The configuration of cardholder computing device 402 is also representative of point-of-sale device 212.

Cardholder computing device 402 includes one or more processors 405 for executing instructions. In some embodiments, executable instructions are stored in a memory area 410. Processor 405 may include one or more processing units (e.g., in a multi-core configuration). One or more memory devices 410 are any one or more devices allowing information such as executable instructions and/or other data to be stored and retrieved. One or more memory devices 410 may include one or more computer-readable media.

Cardholder computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Cardholder computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in one or more memory devices 410 are, for example, computer-readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a website from server system 202 or a web server associated with a merchant. A client application allows user 401 to interact with a server application from server system 202 or a web server associated with a merchant.

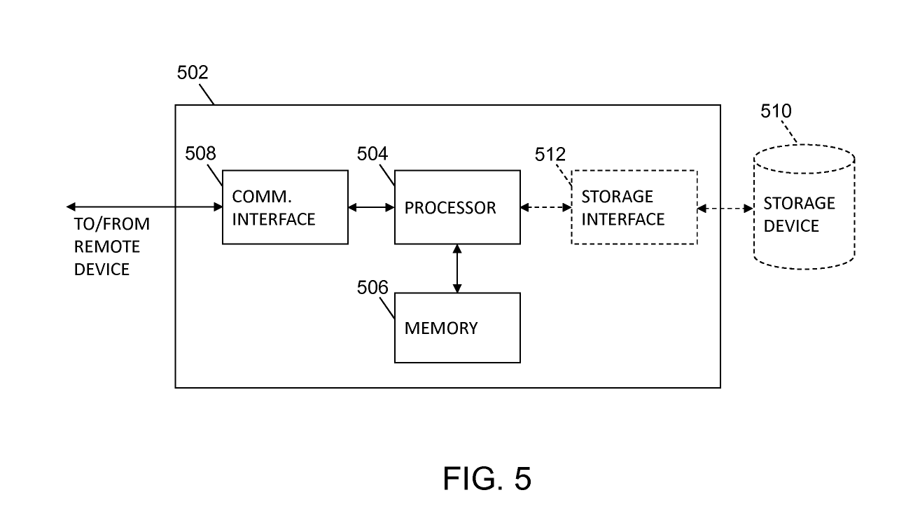

FIG. 5 illustrates an example configuration of a server computing device 502 such as server system 202 (shown in FIGS. 2 and 3). Server computing device 502 may include, but is not limited to, database server 206, application server 302, web server 304, fax server 306, directory server 308, and mail server 310. Server computing device 502 is also representative of suggestion computing device 210.

Server computing device 502 includes one or more processors 504 for executing instructions. Instructions may be stored in one or more memory devices 506, for example. One or more processors 504 may include one or more processing units (e.g., in a multi-core configuration).

One or more processors 504 are operatively coupled to a communication interface 508 such that server computing device 502 is capable of communicating with a remote device such as cardholder computing device 402 or another server computing device 502. For example, communication interface 508 may receive requests from client systems 204 via the Internet, as illustrated in FIGS. 2 and 3.

One or more processors 504 may also be operatively coupled to one or more storage devices 510. One or more storage devices 510 are any computer-operated hardware suitable for storing and/or retrieving data. In some embodiments, one or more storage devices 510 are integrated in server computing device 502. For example, server computing device 502 may include one or more hard disk drives as one or more storage devices 510. In other embodiments, one or more storage devices 510 are external to server computing device 502 and may be accessed by a plurality of server computing devices 502. For example, one or more storage devices 510 may include multiple storage units such as hard disks or solid state disks in a redundant array of inexpensive disks (RAID) configuration. One or more storage devices 510 may include a storage area network (SAN) and/or a network attached storage (NAS) system. In some embodiments, one or more storage devices 510 may include database 208.

In some embodiments, one or more processors 504 are operatively coupled to one or more storage devices 510 via a storage interface 512. Storage interface 512 is any component capable of providing one or more processors 504 with access to one or more storage devices 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 504 with access to one or more storage devices 510.

One or more memory devices 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

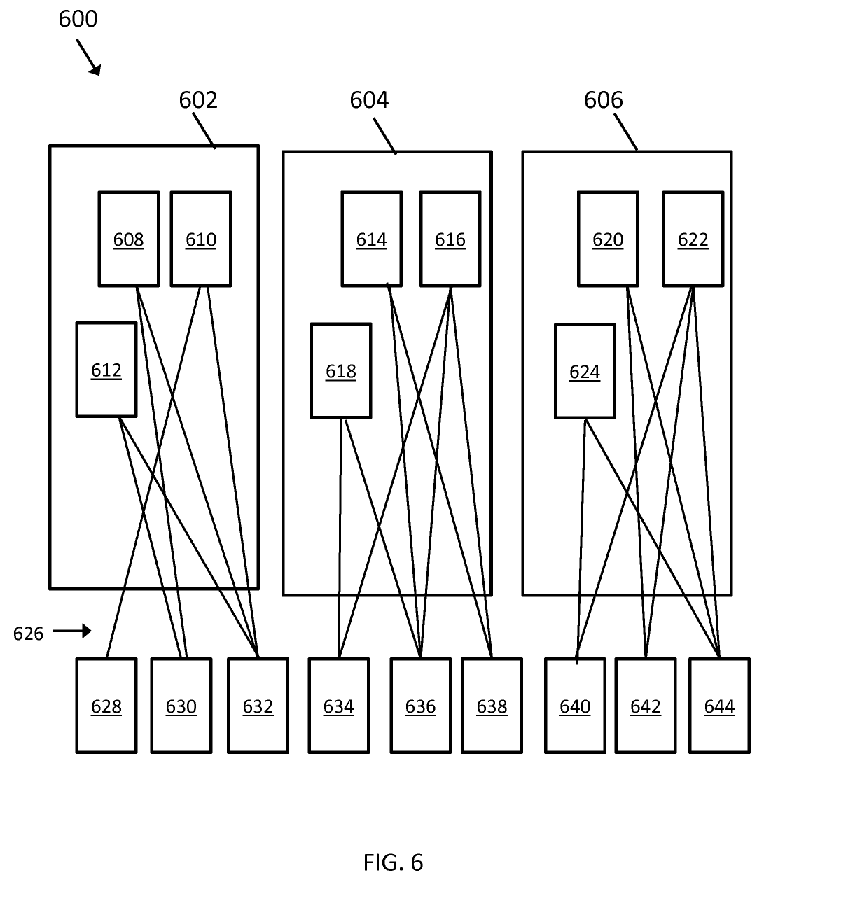

FIG. 6 is a block diagram of an example relationship 600 between cardholders 608, 610, 612, 614, 616, 618, 620, 622, and 624, merchants 628, 630, 632, 634, 636, 638, 640, 642, and 644, and categories 602, 604, 606 that the cardholders fall into based on purchases 626 from the merchants. More specifically, database 208 (FIG. 2) includes stored transaction data representing transactions 626 (i.e., purchases of goods) made by cardholders with merchants. For example, the stored transaction data indicates that first cardholder 608 made one or more purchases from second merchant 630 and third merchant 632. The stored transaction data also indicates that second cardholder 610 made one or more purchases from first merchant 628 and third merchant 632. Additionally, third cardholder 612 made one or more purchases from second merchant 630 and third merchant 632. Server system 202 associates with first cardholder 608, second cardholder 610, and third cardholder 612 with a first category 602, based at least in part on the fact that cardholders 608, 610, and 612 purchased from a common set of merchants (e.g., first merchant 628, second merchant 630, and third merchant 632). Additionally, server system 202 may base the categorization on specific goods purchased from the merchants, a price paid, or average price paid (“average transaction amount”) associated with the purchases, and/or a frequency of purchases associated with each of the cardholders 608, 610, and 612 during a predefined time period, such as one month. The categorization may be based on one or more underlying shared characteristics of cardholders 608, 610, and 612, such as a common income range, a common set of hobbies, a common life stage (e.g., a common marital status, a common age range, etc.), or other characteristics. In some implementations, server system 202 may identify what the one or more shared underlying characteristics are.

Similarly server system 202 associates fourth cardholder 614, fifth cardholder 616, and sixth cardholder 618 with a second category 604 based at least in part on purchases 626 made from merchants 634, 636, and 638. Likewise, server system 202 associates seventh cardholder 620, eighth cardholder 622, and ninth cardholder 624 with a third category 606 based at least in part on purchases 626 made by cardholders 620, 622, and 624 from merchants 640, 642, and 644. As should be appreciated from the description above, while first category 602 is associated with purchases made from first merchant 628, second merchant 630, and third merchant 632, in some implementations, one or more cardholders within first category 602 may also make purchases from one or more of merchants 634, 636, 638, 640, 642, and 644. More specifically, in some implementations, the categorization is based not solely on which merchants the cardholders purchase from, but may additionally or alternatively be based on one or more of specific goods purchased, purchase amounts, frequencies of purchases, and/or other factors.

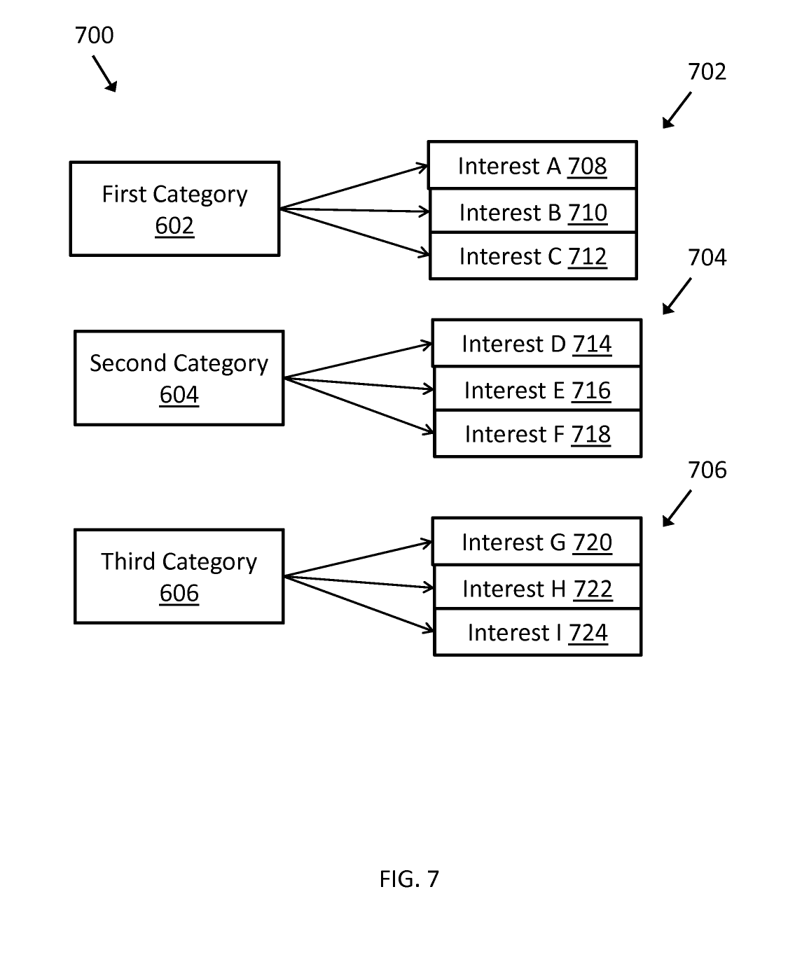

FIG. 7 is a block diagram of an example relationship 700 between categories 602, 604, and 606 and interests 708. 710, 712, 714, 716, 718, 720, 722, and 724 associated with the categories 602, 604, and 606. More specifically, first category 602 is associated with interest A 708, interest B 710, and interest C 712. Second category 604 is associated with interest D 714, interest E 716, and interest F 718. Third category 606 is associated with interest G 720, interest H 722, and interest I 724. Each interest represents a set of goods that merchants, such as merchants 628, 630, 632, 634, 636, 638, 640, 642, and/or 644 sell. Importantly, while a particular cardholder, such as second cardholder 610 may not have purchased any goods from second merchant 630, which sells luxury vehicles, given that second cardholder 610 is in first category 602, second cardholder 610 likely shares many of the same interests as first cardholder 608 and third cardholder 612. In other words, while the stored transaction data in database 208 may indicate that second cardholder 610 has purchased from first merchant 628, which sells golf equipment and corresponds with interest A 708 (i.e., golf), and from third merchant 632, which sells business suits and corresponds with interest C 712 (i.e., business attire), second cardholder 610 is likely to also share interest B 710, which is luxury vehicles.

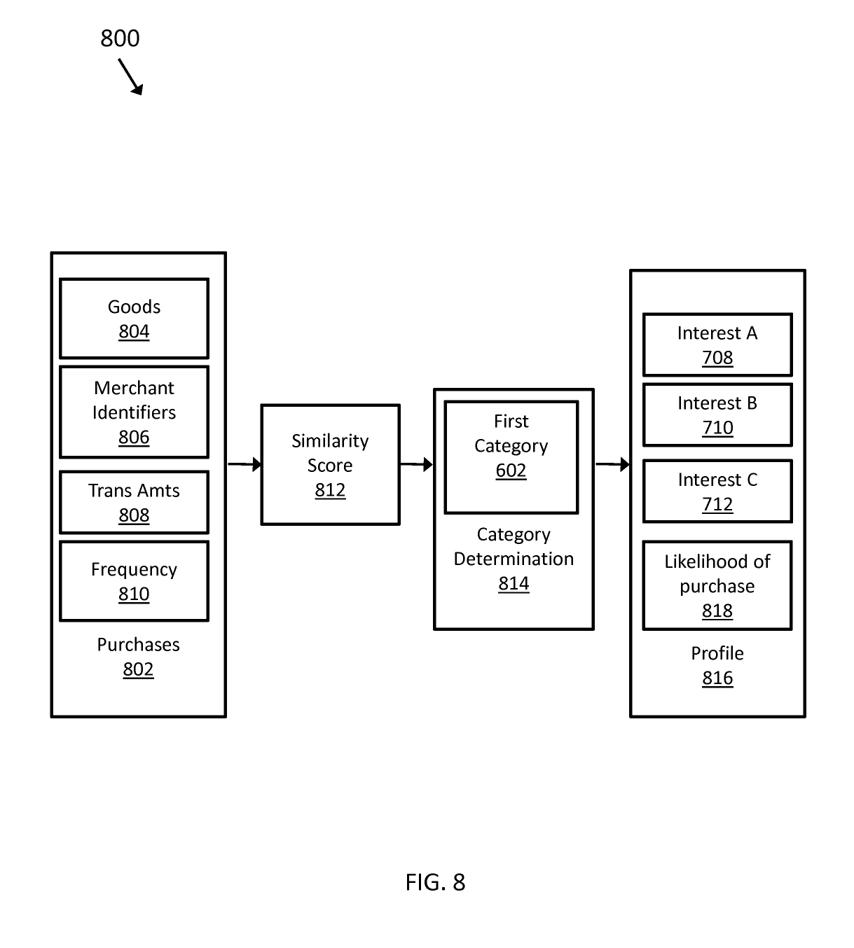

FIG. 8 is a block diagram of an example data flow 800 from purchases 802 made by a cardholder, such as cardholder 122 to a profile 816 of the cardholder. Purchases 802 are included in the stored transaction data in database 208. Included within the information associated with purchases 802 are identifications of goods 804, merchant identifiers 806, transaction amounts 808, and/or frequencies of purchases. Server system 202 compares such information associated with purchases 802 of cardholder 122 with one or more other cardholders (e.g., cardholders 608, 610, 612, 614, 616, 618, 620, 622, and/or 624) and determines a similarity score 812 based on purchases of such cardholders. For example, in some implementations, server system 202 determines a similarity score for each comparison of purchases 802 of cardholder 122 to purchases of each cardholder 608, 610, 612, 614, 616, 618, 620, 622, and/or 624. The similarity score may be, for example, a percentage or other numeric value. In the example, server system 202 determines that greater similarity scores are generated when comparing purchases of cardholder 122 to purchases made by cardholders in first category 602. Accordingly, server system 202 generates a category determination 814 designating first category 602. Based at least in part on category determination 814, sever system 202 generates a profile 816 that includes interests 708, 710, 712 associated with first category 602. Additionally, in some implementations, server system 202 determines and stores a likelihood of purchase score 818. Likelihood of purchase score 818 represents a likelihood that cardholder 122 will buy a good associated with one of the interests 708, 710, 712 in profile 816. In some implementations, likelihood of purchase score 818 includes a percentage or other numeric value representing the likelihood of the purchase. For example, cardholder 122 may be likely to purchase a luxury vehicle because cardholders in first category 602 demonstrate a shared interest in luxury vehicles and the stored transaction data associated with cardholder 122 does not indicate that cardholder 122 has purchased a luxury vehicle yet. Additionally or alternatively, likelihood of purchase score 816 may represent a relatively high likelihood that cardholder 122 will purchase golf equipment based on a relatively high frequency 810 of purchases of golf equipment in the stored transaction data associated with cardholder 122 (i.e., purchases 802).

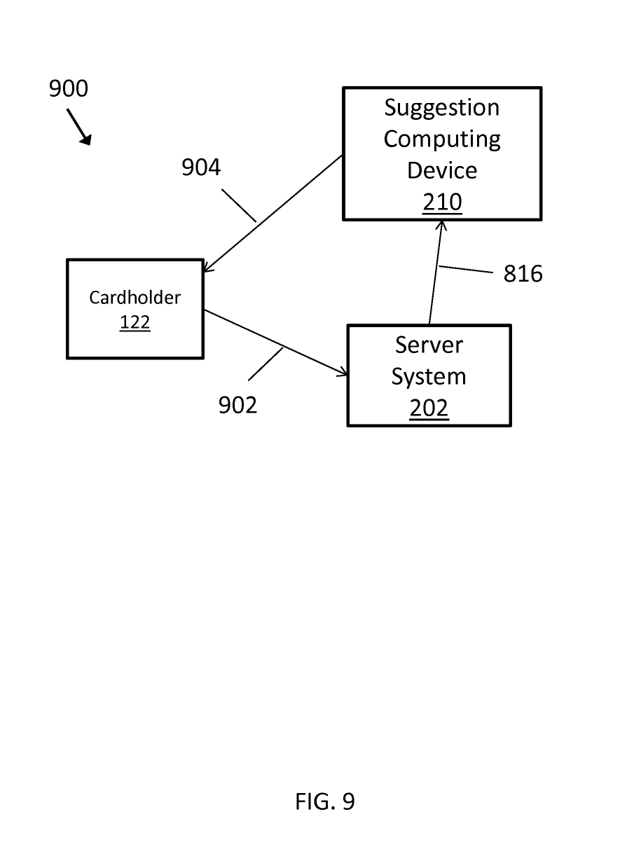

FIG. 9 is a block diagram of example communications 900 among cardholder 122, server system 202, and suggestion computing device 210. More specifically, prior to server system 202 generating profile 816, cardholder 122 transmits an indication of agreement 902 for server system 202 to generate profile 816. In some implementations, cardholder 122 transmits the indication of agreement 902 using a client computing device 204. For example, cardholder 122 may transmit the indication of agreement 902 through a webpage (not shown) hosted, for example, by server system 202 and displayed on client computing device 204. Server system 202 transmits profile 816 to suggestion computing device 210. As described above, in some implementations, suggestion computing device 210 may be integrated or included within server system 202. In other implementations, suggestion computing device 210 may be associated with a third party other than a party operating server system 202. Based at least in part on profile 816, suggestion computing device 210 transmits a suggestion 904 to cardholder 122 to purchase one or more goods. For example, suggestion computing device 210 may include the suggestion in an electronic message, such as an email, instant message, or text message, or in a webpage displayed to cardholder 122 on client computing device 204.

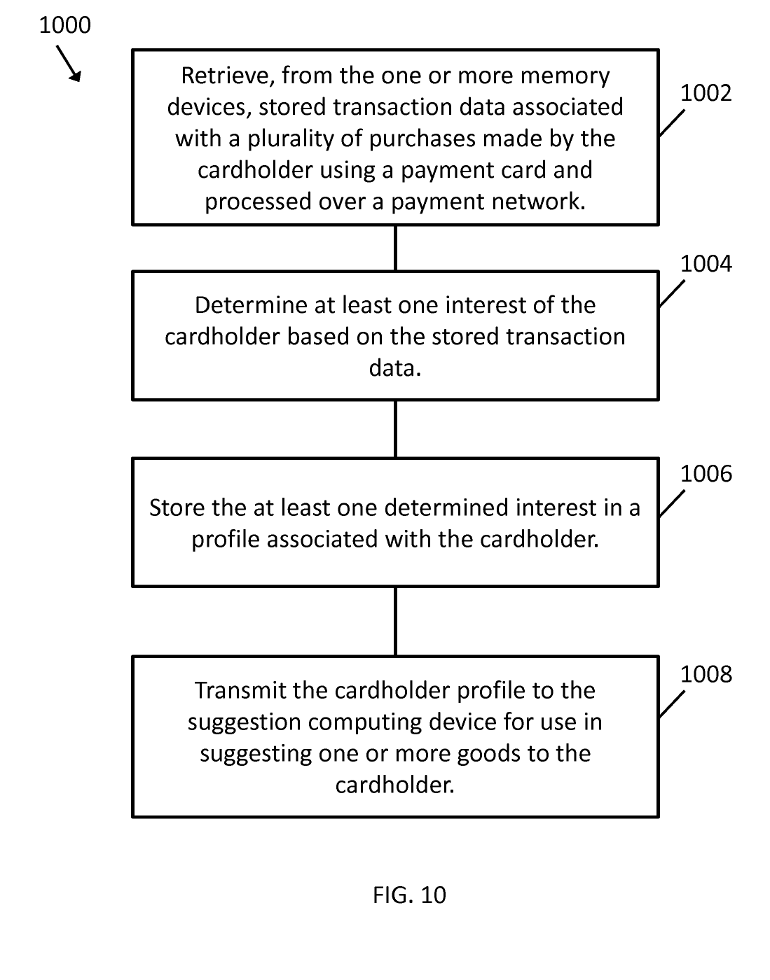

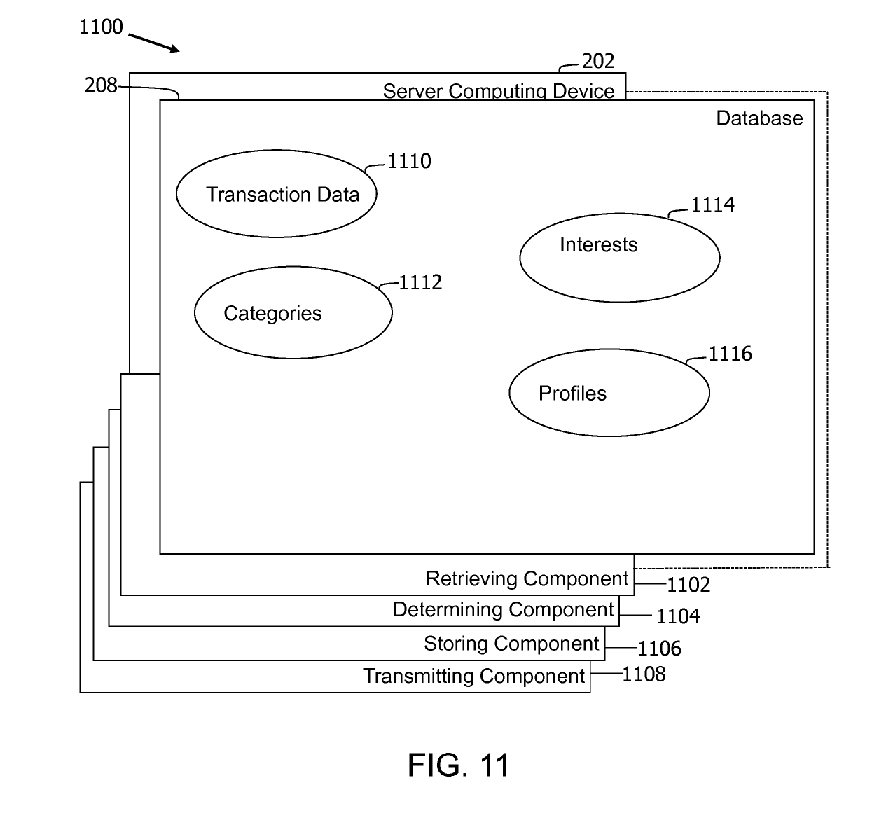

FIG. 10 is a flowchart of an example process 1000 that may be performed by payment processing system 200, and more specifically, by server system 202, for providing a profile associated with a cardholder (e.g., cardholder 122) to suggestion computing device 210. Initially, server system (“server computing device”) 202 retrieves 1002 from one or more memory devices, such as database 208, stored transaction data 1110 (FIG. 11) associated with a plurality of purchases 802 (FIG. 8) made by cardholder 122 using a payment card and processed over payment network 128. Additionally, server computing device 202 determines 1004 at least one interest (e.g., interest A 708, interest B 710, interest C 712) of cardholder 122 based on the stored transaction data 1110. Additionally, server computing device 202 stores 1006 the at least one determined interest (e.g., interest A 708, interest B 710, interest C 712) in profile 816 associated with cardholder 122. Additionally, server computing device 202 transmits 1008 the cardholder profile 816 to suggestion computing device 210 for use in suggesting one or more goods to cardholder 122.

In some implementations, in determining at least one interest of cardholder 122, server computing device 202 compares purchases 802 of cardholder 122 to a reference set of purchases associated with at least a second cardholder (e.g., purchases 626 of cardholders 608, 610, 612, 614, 616, 618, 620, 622, and 624). In some implementations, server computing device 202 compares purchases 802 made by cardholder 122 to a reference set of purchases associated with at least one predefined category (e.g., first category 602), determines a similarity score 812 of the purchases 802 to the reference set of purchases, and associates cardholder 122 with the predefined category (e.g., first category 602) based on the similarity score 812. In some implementations, server computing device 202 determines that the stored transaction data 1110 does not include a purchase of a particular good by cardholder 122 and determines a likelihood score 818 representing a likelihood that cardholder 122 will purchase the particular good based on the determined interest (e.g., interest B 710). In some implementations, server computing device 202 identifies at least one good purchased by cardholder 122 based at least in part on an authorization request message transmitted from a merchant (i.e., from POS device 212). In some implementations, server computing device 202 identifies a first merchant (e.g., first merchant 628) associated with the stored transaction data 1110 and determines the at least one interest based on a predefined set of interests associated with the first merchant 628 (e.g., golf). In some implementations, server computing device 202 determines an average transaction amount associated cardholder 122. For example, in some implementations, server computing device 202 determines an average transaction amount for purchases made by cardholder 122 from first merchant 628. In some implementations, server computing device 202 determines a frequency 810 of purchases made by cardholder 122 within a predetermined time period (e.g., one month). For example, in some implementations, server computing device 202 determines a frequency 810 of purchases made by cardholder 122 from first merchant 628 during one month. In some implementations, server computing device 202 receives an indication 902 from cardholder 122 that cardholder 122 agrees to generation of profile 816 and to transmission of profile 816 for use in suggesting one or more goods to cardholder 122.

FIG. 11 is a diagram 1100 of components of one or more example computing devices, for example server computing device 202, that may be used in embodiments of the described systems and methods. FIG. 11 further shows a configuration of database 208 (FIG. 2). Database 208 is communicatively coupled to server computing device 202.

Server computing device 202 includes a retrieving component 1102 for retrieving, from one or more memory devices, such as database 208, stored transaction data 1110 associated with a plurality of purchases 802 made by cardholder 122 using a payment card and processed over payment network 128. Server computing device 202 additionally includes a determining component 1104 for determining at least one interest of cardholder 122 based on the stored transaction data 1110. Additionally, server computing device 202 includes a storing component 1106 for storing the at least one determined interest in a profile 816 associated with cardholder 122. Server computing device 202 also includes a transmitting component 1108 for transmitting the cardholder profile 816 to suggestion computing device 210 for use in suggesting one or more goods to cardholder 122.

In an example embodiment, database 208 is divided into a plurality of sections, including but not limited to, a transactions data section 1110, a categories section 1112, an interests section 1114, and a profiles section 1116. These sections within database 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The embodiments of the method and system described above provide a profile associated with a cardholder to a suggestion computing device, wherein the profile is based on purchases made across multiple merchants rather than a specific merchant. Accordingly, the suggestion computing device is able to provide more informed suggestions for goods as compared to known systems for suggesting goods to a potential customer.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for providing a profile associated with a cardholder to a suggestion computing device, said method implemented using a computing device in communication with one or more memory devices, said method comprising:
retrieving, from the one or more memory devices, stored transaction data associated with a plurality of purchases made by a cardholder using a payment card and processed over a payment network;
determining at least one interest of the cardholder based on the stored transaction data;
storing the at least one determined interest in a profile associated with the cardholder; and
transmitting the cardholder profile to the suggestion computing device for use in suggesting one or more goods to the cardholder.

2. The method of claim 1, wherein the cardholder is a first cardholder, and wherein determining at least one interest further comprises comparing the purchases made by the first cardholder to a reference set of purchases associated with at least a second cardholder.

3. The method of claim 1, further comprising:
comparing the purchases made by the cardholder to a reference set of purchases associated with at least one predefined category;
determining a similarity score of the purchases to the reference set of purchases; and
associating the cardholder with the predefined category based on the similarity score.

4. The method of claim 1, further comprising:
determining that the stored transaction data does not include a purchase of a particular good by the cardholder; and
determining a likelihood score representing a likelihood that the cardholder will purchase the particular good based on the determined interest.

5. The method of claim 1, further comprising:
identifying at least one good purchased by the cardholder based at least in part on an authorization request message transmitted from a merchant.

6. The method of claim 1, further comprising:
identifying a first merchant associated with the stored transaction data; and
determining the at least one interest based on a predefined set of interests associated with the first merchant.

7. The method of claim 6, further comprising determining an average transaction amount associated with the at least one purchase made by the cardholder from the first merchant.

8. The method of claim 1, wherein determining the at least one interest further comprises determining a frequency of purchases from the first merchant within a predetermined time period.

9. The method of claim 1, further comprising receiving an indication from the cardholder that the cardholder agrees to generation of the profile and transmission of the profile for use in suggesting one or more goods to the cardholder.

10. The method of claim 1, wherein transmitting the cardholder profile to the suggestion computing device further comprises transmitting the at least one determined interest to the suggestion computing device, wherein the suggestion computing device is configured to provide a suggestion to the cardholder computing device to purchase the one or more goods based on the at least one determined interest.

11. A computing device for providing a profile associated with a cardholder to a suggestion computing device, said computing device comprising one or more processors in communication with one or more memory devices, said computing device configured to:
retrieve, from the one or more memory devices, stored transaction data associated with a plurality of purchases made by a cardholder using a payment card and processed over a payment network;
determine at least one interest of the cardholder based on the stored transaction data;
store the at least one determined interest in a profile associated with the cardholder; and
transmit the cardholder profile to the suggestion computing device for use in suggesting one or more goods to the cardholder.

12. The computing device of claim 11, wherein the cardholder is a first cardholder, and said computing device is further configured such that determining at least one interest further comprises comparing the purchases made by the first cardholder to a reference set of purchases associated with at least a second cardholder.

13. The computing device of claim 11, further configured to:
compare the purchases made by the cardholder to a reference set of purchases associated with at least one predefined category;
determine a similarity score of the purchases to the reference set of purchases; and
associate the cardholder with the predefined category based on the similarity score.

14. The computing device of claim 11, further configured to:
determine that the stored transaction data does not include a purchase of a particular good by the cardholder; and
determine a likelihood score representing a likelihood that the cardholder will purchase the particular good based on the determined interest.

15. The computing device of claim 11, further configured to identify at least one good purchased by the cardholder based at least in part on an authorization request message transmitted from a merchant.

16. The computing device of claim 11, further configured to:
identify a first merchant associated with the stored transaction data; and
determine the at least one interest based on a predefined set of interests associated with the first merchant.

17. The computing device of claim 16, further configured to determine an average transaction amount associated with the at least one purchase made by the cardholder from the first merchant.

18. The computing device of claim 11, further configured such that determining the at least one interest further comprises determining a frequency of purchases from the first merchant within a predetermined time period.

19. The computing device of claim 11, further configured to receive an indication from the cardholder that the cardholder agrees to generation of the profile and transmission of the profile for use in suggesting one or more goods to the cardholder.

20. A computer-readable storage medium having computer-executable instructions embodied thereon, wherein when executed by a computing device having one or more processors in communication with one or more memory devices, the computer-executable instructions cause the computing device to:
retrieve, from the one or more memory devices, stored transaction data associated with a plurality of purchases made by a cardholder using a payment card and processed over a payment network;
determine at least one interest of the cardholder based on the stored transaction data;
store the at least one determined interest in a profile associated with the cardholder; and
transmit the cardholder profile to the suggestion computing device for use in suggesting one or more goods to the cardholder.
